(19) United States
(12) Patent Application Publication
(10) Pub. No.: US 2022/0398901 A1
(43) Pub. Date: Dec. 15, 2022

(54) Biometric Automated Teller Machine

(71) Applicant: Carla Vazquez, Corpus Christi, TX (US)

(72) Inventor: Carla Vazquez, Corpus Christi, TX (US)

(21) Appl. No.: 17/520,923

(22) Filed: Nov. 8, 2021

Related U.S. Application Data
(60) Provisional application No. 63/208,565, filed on Jun. 9, 2021.

(51) Int. Cl. G07F 19/00; G06F 21/32; G06K 9/00

(52) U.S. Cl. CPC G07F 19/206; G07F 19/209; G06F 21/32; G07F 19/201; G06K 9/0004; G06K 9/00597

(57) ABSTRACT

The present invention relates to a biometric automated teller machine that uses biometrics to authenticate a user rather than a bank card and personal identification number. The biometric automated teller machine comprises a biometric scanner configured to scan the fingerprint of the user and a camera configured to scan the iris and retina of the user. The captured biometric is compared with biometrics that have been registered by the user for the purpose of authentication. The biometric automated teller machine enables the user to withdraw cash and perform other actions in a safer, more convenient, and simpler manner than do current automated teller machines.

### CROSS-REFERENCE TO RELATED APPLICATION

The present application claims priority to, and the benefit of, U.S. Provisional Application No. 63/208,565, which was filed on Jun. 9, 2021, and is incorporated herein by reference in its entirety.

### FIELD OF THE INVENTION

The present invention relates generally to the field of automated teller machines (ATMs). More specifically, the present invention relates to an ATM that uses biometrics in the form of an image of a user's fingerprint, iris or retina to access financial accounts. The user's biometrics are paired with one or more of the user's financial accounts. The biometric ATM offers a fingerprint scanner for obtaining images of the user's fingerprints and a camera for obtaining images of the user's iris or retina. Biometric authentication provides ATM users access to their accounts without using a card or a personal identification number. Accordingly, this disclosure makes specific reference thereto the present invention. Nonetheless, it is to be appreciated that aspects of the present invention are also equally applicable to other applications, devices and methods of manufacture.

### BACKGROUND

By way of background, the automated teller machine, also known as an ATM, is a specialized computer that allows a user to manage funds of one or more financial accounts most anytime of the day or night. It is popularly used to withdraw cash. An ATM also allows a user to check account balances, deposit money, or print a statement of account activities. The ATM is one of life's modern conveniences, easing the life of bank account holders at all times of the day, all over the world.

An increased use of ATMs has been accompanied by increased fraud and abuse of ATMs associated with the current method of use of ATMs. To operate an ATM, a financial card such as a credit/debit card is inserted into or swiped through a card reader slot disposed on the ATM. After a successful authentication of the card by the ATM, the individual (cardholder) generally has to input a password associated with the card such as a Personal Identification Number (PIN). Fraud and abuse occur when the ATM card is cloned, stolen, or lost, which may lead to unauthorized financial transactions and financial loss to the cardholder. Cards may also be stolen and lost when the ATM user is in a hurry and the user leaves the ATM, forgetting the card is still inserted in the ATM. A thief may then retrieve the card after the user's departure. If the thief had observed the user enter his or her PIN, the thief may also be able to use the stolen card and the PIN to access the user's bank account.

Further, although ATMs are considered to be a modern convenience, there are still a number of inconveniences and complications associated with their use. One such convenience is the need to carry a card and to remember the associated PIN. This inconvenience is multiplied when individuals carry multiple cards and each card is associated with a different PIN number. Further, a cardholder may forget the unique PIN associated with one or more cards, and in such cases the cardholder is unable to perform the banking operation. Upon repeated errors in entering a PIN, the ATM may confiscate the user's card, thereby requiring the user to contact the bank in order to retrieve the card days later, which is undesirable. In some cases, the cardholder may forget to carry the card and therefore is not able to withdraw the cash or perform any other function at the ATM. In addition, although ATMs may seem to be relatively simple to use, elderly or disabled individuals may have difficulty while trying to find the slot and insert the card into the slot, and then also enter a PIN specifically associated with said card using a keypad.

Therefore, users desire an improved ATM machine that is more secure, convenient and simpler to use. As such, there exists a long-felt need in the art for an improved ATM that eliminates the process of using financial cards such as a debit card, credit card or any other type of financial card for performing transactions on an ATM. Additionally, there is a long-felt need in the art for an improved ATM that eliminates the need to physically insert or scan a financial card each time an individual wants to perform a transaction at an ATM. Moreover, there is a long-felt need in the art for an improved ATM that offers a safer and more secure system of using the ATM while performing transactions such as withdrawing money, depositing money, checking account balances or any other activity normally performed at an ATM. Further, there is a long-felt need in the art for an ATM that protects a cardholder from fraud that may result when a card is cloned, lost or stolen. In addition, there is a long-felt need in the art for an improved ATM that provides an alternate, more convenient way of authenticating a user and thereby allows a user to access his or her financial accounts than does the current ATM, which relies on a card and PIN. Finally, there is a long-felt need in the art for an ATM that features a combination financial card reader slot and biometric scanner.

The subject matter disclosed and claimed herein, in one embodiment thereof, comprises a biometric automated teller machine that authenticates a user based on at least one biometric of the user, and not on the authentication of the financial card such as a credit card or debit card and the card's associated PIN. More specifically, the biometric automated teller machine further comprises a biometric scanner for scanning one or more fingerprints of the user, the biometric scanner is connected to a biometric module housed within the body of the ATM, the biometric module having a conversion module for converting the scanned fingerprint into a digital image, an authentication module for authenticating the scanned fingerprint after comparing the digital image of the scanned fingerprint with one or more digital images stored in one or more databases at a data center wherein the data center is remote to the ATM and is connected to the ATM via a communication network, and an activation module for activating a display and cash dispenser of the ATM upon successful authentication of the scanned fingerprint. In this manner, the biometric automated teller machine of the present invention accomplishes all of the foregoing objectives of providing a safer, more convenient and simpler system for performing transaction with an ATM.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a biometric automated teller machine. The biometric automated teller machine is configured to allow a user to access his or her financial accounts using at least one user biometric rather than a financial card and associated personal identification number. The biometric automated teller machine is comprised of a biometric scanner configured to scan one or more fingerprints of a user, the biometric scanner is connected to a biometric module housed within the body of a biometric automated teller machine, a conversion module for converting the scanned fingerprint into a digital image, an authentication module for authenticating the user by comparing the digital image of the fingerprint with one or more digital images stored in one or more databases at a data center wherein the data center is remote to the biometric automated teller machine, and is coupled with the biometric automated teller machine via a communication network, and an activation module for activating a display and cash dispenser on the biometric automated teller machine upon successful authentication of the user.

In a further embodiment of the present invention, a biometric automated teller machine configured to provide banking operations is disclosed. The biometric automated teller machine includes an electronic pad for obtaining an image of a user's fingerprint, wherein the fingerprint image is paired with one or more financial cards and/or one or more bank accounts, and a camera for capturing the image of the user's iris or retina, wherein the image of the iris or retina is paired with one or more financial cards and/or one or more bank accounts, wherein the biometric automated teller machine provides banking operation options to the user on successful authentication of at least one of the biometrics.

In a further embodiment of the present invention, the biometric automated teller machine has, in addition to the elements forementioned, a card reader for receiving a financial card such as a debit or credit card, is configured to read the magnetic strip or microchip of the financial card, has a keypad for enabling the user to enter a unique PIN, a printer for printing the receipt or a bank statement, a touch-display configured for receiving input from the user and displaying a plurality of outputs relating to banking operation options and a camera configured to obtain an image of the user's face.

In yet another embodiment of the present invention, a method of secure ATM operation is provided. The method includes the steps of initially registering one or more fingerprints of a user, storing the registered fingerprints in one or more databases and pairing the registered fingerprints with one or more bank accounts or financial cards. The method further involves imaging a fingerprint of a user, the image being used to authenticate the user's identity, thereby allowing the user to access the user's financial accounts with the biometric automated teller machine.

In yet another embodiment of the present invention, a method for securely providing banking operations by a biometric automated teller machine is provided. The method includes the steps of initially registering an image of a user's iris or retina, storing the registered image in one or more databases and pairing the registered image with one or more bank accounts or financial cards. The method further involves obtaining an image of a user's iris or retina for authentication of a user's identity, the authentication based on a match of the obtained image with registered images that are paired with a user's bank account, whereby access to a user's account is gained allowing the biometric automated teller machine to perform financial transactions involving these user accounts.

In yet another embodiment, the method further comprises the use of a financial card for performing banking operations with a biometric automated teller machine. This method allows the user to access his or her accounts when the biometric scanner is not available. It also allows a user to register his or her biometric images using the biometric automated teller machine by using a card to access his or her accounts, obtaining an image of the biometrics, and linking the biometric image to the bank account associated with the card. This allows the user to eliminate the future need of using a card in a biometric automated teller machine, thus providing a method for a safer, more convenient and simpler means of using an ATM.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the biometric automated teller machine of the present invention in accordance with the disclosed architecture;

FIG. 2 illustrates a schematic view showing one potential embodiment of the connection of one potential embodiment of the biometric automated teller machine of the present invention with an ATM/bank datacenter via a communication network in accordance with the disclosed architecture;

FIG. 3 illustrates a block diagram showing one potential embodiment of a biometric module that is placed within one potential embodiment of the biometric automated teller machine of the present invention for processing the captured biometrics of a user in accordance with the disclosed architecture;

FIG. 4 illustrates a flowchart showing an exemplary process of registration of the biometric of a user that would be used for authentication in one potential embodiment of the biometric automated teller machine of the present invention in accordance with the disclosed architecture;

FIG. 5 illustrates a flowchart showing an exemplary method of performing banking operations on one potential embodiment of the biometric automated teller machine of the present invention using a biometric instead of using a financial card in accordance with the disclosed architecture;

FIG. 6 illustrates a flow chart showing use of an iris pattern as a biometric for allowing banking operations using one potential embodiment of the biometric automated teller machine of the present invention in accordance with the disclosed architecture;

FIG. 7 illustrates a flow diagram showing an exemplary method of performing operations on one potential embodiment of the biometric automated teller machine of the present invention using a financial card in a conventional manner in accordance with the disclosed architecture; and

FIG. 8 illustrates an exemplary user performing banking operations on one potential embodiment of the biometric automated teller machine of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved ATM that eliminates the process of using financial cards such as a debit card, credit card or any other type of financial card for performing transactions on ATM machine. Additionally, there is a long-felt need in the art for an improved ATM that eliminates the need to physically insert or scan a financial card each time an individual wants to perform a transaction on the ATM. Moreover, there is a long-felt need in the art of an improved ATM that offers a safer and more secure system of using the ATM, while performing transactions such as withdrawing money, depositing money, checking account balance and more. Further, there is a long-felt need in the art for an ATM that protects a cardholder from card-related fraud, such as theft or cloning of financial cards used in ATMs. Furthermore, there is a long-felt need in the art for an improved ATM that provides a user a biometric alternative to the use of bank cards and personal identification numbers as a means to access a user's financial accounts using an ATM. Finally, there is a long-felt need in the art for an ATM that features a combination financial card reader slot and biometric scanner.

The present invention, in one exemplary embodiment, a novel automated teller machine (ATM) with integrated biometric scanner is disclosed. The disclosed biometric automated teller machine is configured to authenticate a user, based on at least one biometric, such as a fingerprint, and accordingly provide access to the biometric automated teller machine. The biometric automated teller machine comprises of a biometric scanner configured to scan one or more fingerprints of a user, wherein the biometric scanner is connected to a biometric module housed within the body of the biometric automated teller machine. The biometric automated teller machine further includes an authentication module that communicates with authentication servers for the purpose of authenticating the scanned fingerprint and accordingly activating a display and other functions of the biometric automated teller machine. Various embodiments are discussed hereinafter.

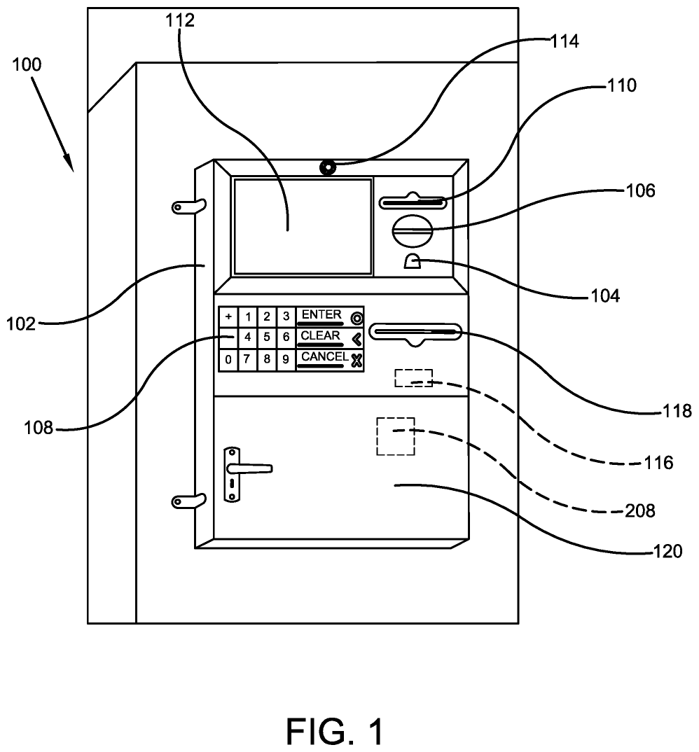

FIG. 1 illustrates a perspective view of one potential embodiment of the biometric automated teller machine of the present invention in accordance with the disclosed architecture. The biometric automated teller machine 100 of the present invention is a device configured to allow a user to obtain cash without using a financial card or personal identification number. The biometric automated teller machine 100 is an improvement of the existing ATM. The biometric automated teller machine 100 authenticates a user by the user's biometric markers such as, but not limited to, at least one fingerprint, at least one iris scan, and/or at least one retina scan. In the preferred embodiment of the present invention, the biometric marker necessary to operate the biometric automated teller machine is one or more fingerprints. Additional embodiments of the present invention include any type of biometric including those known in the art, those known in related arts, and/or later developed technologies.

More specifically, the biometric automated teller machine 100 has a body 102 for housing the various components of the biometric automated teller machine 100. The components can be housed within the body 102 or disposed on the body 102 of the biometric automated teller machine 100. The components that are disposed on the body 102 and are accessible to a user using the biometric automated teller machine 100 and may include at least one biometric scanner 104, at least one card reader 106, at least one keypad 108, at least one printing slot 110, at least one user interface 112, at least one camera 114, and at least one cash dispenser 118. The components for processing user instructions are housed within the body 102 and can include at least one biometric module 116.

The body 102 of the biometric automated teller machine 100 can also be made of a material such as, but not limited to, a heavy-duty plastic, a lightweight metal, iron, aluminum, wood, fiberglass, hardened plastic, chromed steel, stainless steel or like materials. Embodiments of the present invention are intended to include or otherwise cover any type of material for the body 102 of the biometric automated teller machine 100 including known, related art, and/or later developed technologies. According to embodiments of the present invention the biometric automated teller machine 100 can be of different shapes and sizes, such as, but not limited to, a cuboid, a cube, a square, and a rectangle. According to an embodiment of the present invention, the biometric automated teller machine 100 may be a through-the-wall automated teller machine 100. According to another embodiment of the present invention, the biometric automated teller machine 100 may be a free-standing automated teller machine 100.

The biometric scanner 104 of the biometric automated teller machine 100 is preferably a complementary metal oxide semiconductor (CMOS)-based optical reader and is used for capturing one or more fingerprints of the user for verification of identity of the user. The scanner 104 uses optical sensing technology that efficiently recognizes poor quality fingerprints easily, and in one embodiment can be a 500 dots per inch (dpi) optical fingerprint sensor. Preferably, the fingerprint scanner 104 can register four fingers and/or two thumbs of a user.

The fingerprint scanner 104 is used for registration and authentication of the user. Once the user's fingerprint is successfully registered, the user can use the fingerprint for authentication on any biometric automated teller machine 100 in the network of the bank to access any financial account linked to the network. The biometric scanner 104 scans the fingerprint of the user and compare an image of the fingerprint to one or more registered fingerprint images of the user stored in one or more databases. On a successful match of the captured fingerprint with the stored fingerprints in the database, the biometric automated teller machine 100 allows the user to perform operations on the biometric automated teller machine 100 without use of a financial card or a personal identification number.

One advantage of the biometric automated teller machine 100 of the present invention is that it also supports the financial card reader functionality. The card reader 106 disposed on the body 102 is configured to receive a financial card. The card reader 106 is designed to read the cardholder and account information encoded in a credit or debit card. Also, the card reader 106 can decode the information contained in a card's magnetic strip or microchip. The card reader 106 is provided in the biometric automated teller machine 100 for backward compatibility and for the users and cases where the biometric authentication is not enabled. This is useful during times of a pandemic, when people may not want to touch a fingerprint scanner surface. It also allows a card holder to lend his or her card and PIN to a family member who would otherwise not be able to access the account using biometrics.

The keypad 108 may be configured to enable the user to enter the personal identification number when the financial card is used to access the biometric automated teller machine 100. The keypad 108 can be a number pad with a plurality of numbers embossed and/or printed from 0 to 9. Apart from the numbers, the keypad 108 can have a clear button, a cancel button, an enter button, and so forth. Further, according to embodiments of the present invention, the keypad 108 may have braille script embossed on all buttons of the keypad 108. The braille script may enable the blind user to easily access the biometric automated teller machine 100 and perform banking transactions.

The improved biometric automated teller machine 100 has a printing slot 110 that is connected to a built-in printer 206 and provides printed slips containing the transaction summary and/or account balance. In an embodiment of the present invention, the built-in printer 206 can be a thermal printer that may print the bank statement upon thermal paper. The printing slot 110 is connected to the printer disposed within the body 102 of the biometric automated teller machine 100, according to embodiments of the present invention.

The automated teller machine 100 also has a user interface 112 that can act both as an input device and an output device. The user interface 112 enables the user to input data into the biometric automated teller machine 100. The user interface 112 may be further configured to display output data associated with the biometric automated teller machine 100. Further, the user interface 112 may be, but is not limited to, a digital display, a touch screen display, a graphical user interface or any other display that serves the same function. Embodiments of the present invention are intended to include or otherwise cover any type of the user interface 112, including known, related art, and/or later developed technologies that may be capable of enabling the user to input data and to display an output data. The user interface 112 displays a list of various options that allows the user to perform various transactions based on the selection of a particular option by the user.

Further embodiments of the invention involve using the camera 114 to capture the video and/or image of the user performing the banking operations. The camera 114 may be configured to store the captured video and/or image into a built-in memory (not shown). The camera 114 may be disposed of on top of the biometric automated teller machine 100 such that the user is in the field of view of the camera 114. The camera 114 is also used for iris and retina scanning of the user, to authenticate the user in the same way that the fingerprint scanner 104 is used. In some embodiments of the camera 114, an eye piece may be included to enable the user to better position his or her eye for imaging of the iris and retina. The camera 114 provides an additional biometric authentication method for authentication of the user.

Additional elements of the biometric automated teller machine include a cash dispenser 118, a cash cassette (e.g. a cash-holding area) 208, and a door 120 in the body 102 to access the cash cassette 208. The door 120 allows access to the cash cassette (not shown) of the biometric automated teller machine 100. The cash cassette is designed to hold the stacked currency notes. Each cassette may be loaded with more than one denomination and is used for dispensing the required cash to the user through the cash dispenser 118.

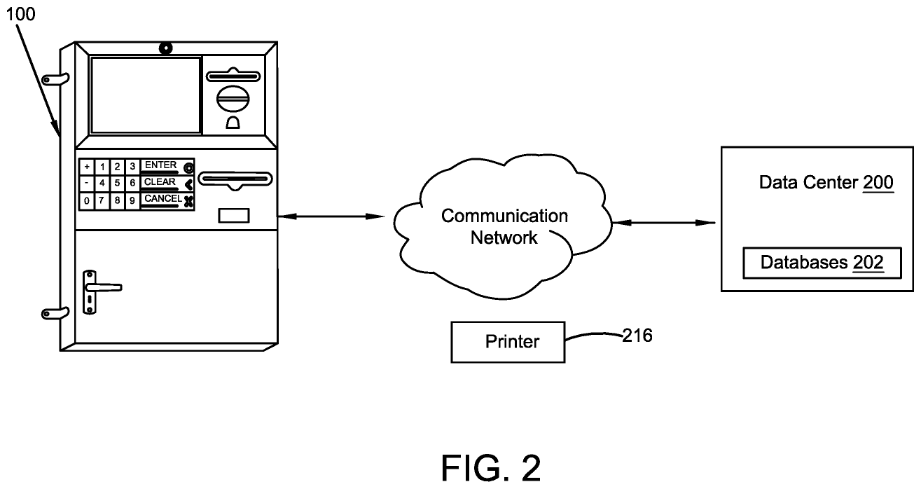

FIG. 2 illustrates a schematic view showing one potential embodiment of the connection of one potential embodiment of the biometric automated teller machine 100 of the present invention with a ATM/bank datacenter via a communication network 204 in accordance with the disclosed architecture. The biometric automated teller machine 100 can have a communication interface that is used for connecting to the data center 200. It should be noted that although only one biometric automated teller machine 100 is shown for simplicity, a plurality of biometric automated teller machines can be connected to the data center 200 via the network 204. Also, the biometric automated teller machines 100 can be connected to each other. As shown in FIG. 2, the biometric automated teller machine 100 is connected to one of the data centers 200 through the communication network 204.

The data center 200 may be a centralized storage location or a distributed data center that stores information related to the users of the banking system. The data center 200 is comprised of hardware that shares and stores data. Further, the data center 200 can have one or more databases 202. In some embodiments of the present invention, the database 202 may be, but is not limited to, a centralized database, a distributed database, a personal database, an end-user database, a commercial database, a Structured Query Language (SQL) database, a non-SQL database, an operational database, a relational database, a cloud database, an object-oriented database, a graph database or other like database that functions as a means to share and store data. Embodiments of the present invention are intended to include or otherwise cover any type of the database 202 including known, related art, and/or later developed technologies

The databases 202 are configured to store the registered user biometric information such as fingerprints, iris scans, retina scans and other biometric information. During registration of the biometric information, the user provides multiple samples of one or more of fingerprints, iris scans, or retina scans. These captured biometrics are stored in the databases 202. When a user provides the biometric, the captured biometric is compared with the stored biometric information in the databases 202 for authentication. The registered biometric information is also correlated with one or more bank accounts and/or financial cards, such as a credit card or a debit card.

The communication network 204 may include a data network such as, but not limited to, an Internet, a Local Area Network (LAN), a Wide Area Network (WAN), a Metropolitan Area Network (MAN), or other like communication network that functions as a means for communication between the biometric automated teller machine 100 and the data center. In some embodiments of the present invention, the communication network 204 may include a wireless network such as, but not limited to, a cellular network and may employ various technologies including an Enhanced Data Rates for Global Evolution (EDGE), a General Packet Radio Service (GPRS) and any other technology that perform the same function. In some embodiments of the present invention, the communication network 204 may include or otherwise cover networks or sub-networks, each of which may include, for example, a wired or a wireless data pathway. According to an embodiment of the present invention, the biometric automated teller machine 100 and the data center 200 may be configured to communicate with each other by one or more communication mediums connected to the communication network 204. The communication mediums include, but are not limited to, a coaxial cable, a copper wire, a fiber optic, a wire that comprise a system bus coupled to a processor of a computing device or other like communication mediums that functions as a means to allow the biometric automated teller machine 100 and the data center 200 to communicate with each other. Embodiments of the present invention are intended to include or otherwise cover any type of the communication mediums, including known, related art, and/or later developed technologies.

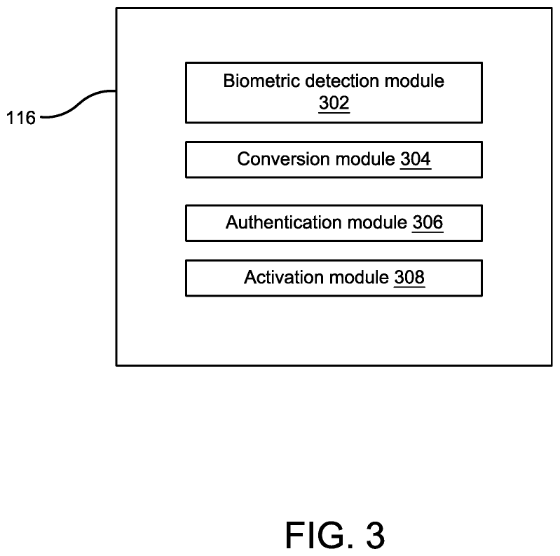

FIG. 3 illustrates a block diagram showing one potential embodiment of a biometric module 116 that is placed within one potential embodiment of the biometric automated teller machine 100 of the present invention for processing the captured biometrics of a user in accordance with the disclosed architecture. The biometric module 116 includes a biometric detection module 302, a conversion module 304, an authentication module 306 and an activation module 308. The biometric detection module 302 is configured to activate the biometric scanner 104 of the biometric automated teller machine 100. In another embodiment of the present invention, the biometric detection module 302 may be configured to activate the camera 114 of the biometric automated teller machine 100. Further, the biometric detection module 302 may receive the fingerprint of a user. In addition, the biometric detection module 302 may receive an image of the user's iris or retina through the camera 114. Furthermore, the received biometric may be transmitted to the conversion module 304. The biometric detection module 302 ensures that a correct and adequate biometric is detected by the biometric module 116. The conversion module 304 is also configured to receive the captured biometric of the user from the biometric detection module 302 and convert the received biometric into a digital image.

The authentication module 306 is configured to compare the digital image of the captured biometric with images stored in one or more databases 202. If the digital image of the captured biometric image matches an image stored in one or more databases 202, the authentication module 306 may authenticate the user. If the authentication module 306 fails to authenticate the biometric then the biometric automated teller machine 100 may pose a few security questions to the user and on answering the questions correctly, the authentication module may authenticate the user. In another exemplary scenario, if the authentication module 306 fails to receive a correct biometric after five consecutive tries, the biometric automated teller machine 100 may display a text “user not registered, please register first”.

The activation module 308 may be configured to generate an activation signal that may activate the user interface 112 along with the cash dispensing mechanism on successful authentication of the fingerprint or any other biometric. Alternatively, the activation signal may activate the user interface and display a text to enter a unique PIN. Upon entry of the unique PIN, the user may enter the amount he or she wants to withdraw, and the same can be dispensed from the cassette.

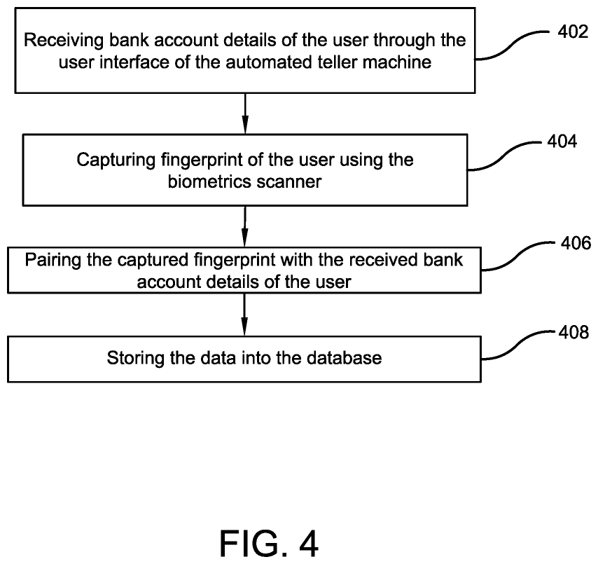

FIG. 4 illustrates a flowchart showing an exemplary process of registration of the biometric of a user that would be used for authentication in one potential embodiment of the biometric automated teller machine 100 of the present invention in accordance with the disclosed architecture. As stated earlier, preferably the biometric that can be used and registered with the biometric automated teller machine 100 of the present invention can be one or more fingerprints. In alternative embodiments of the present invention, the biometric can be an iris scan or a retina scan. For registration of a biometric, initially at step 402, the bank account details and/or card details of a user are received by the biometric automated teller machine 100. The bank/card details can be entered using the user interface and keypad of the biometric automated teller machine 100. At step 404, after the bank and/or card details are entered by the user using the user interface and the keypad, the biometric automated teller machine 100 may prompt the user to scan one or more biometrics. The biometric automated teller machine 100 has a biometric scanner for receiving the fingerprints of the user, and a camera is used for capturing an image of the iris or retina of the user. The biometric automated teller machine 100 is configured to prompt the user to scan the biometrics until clear and accurate biometrics are captured. In one embodiment, a video/image of the user during capturing of the biometric for registration is recorded and can be used for authentication of the user for biometric registration by comparing the captured image/video with the image of the user stored in the bank records.

At step 406, the at least one biometric images of the user are linked with the details of the user's accounts using the user interface and keypad of the biometric automated teller machine 100. The linked biometric will allow the future use of a biometric scan instead of a card and a PIN to access the user's accounts through the biometric automated teller machine 100. At step 408, the registered biometrics of the user are stored in one or more databases 202 along with the information of the user's accounts. The stored data may later be used by the biometric automated teller machine 100 for authentication of the user.

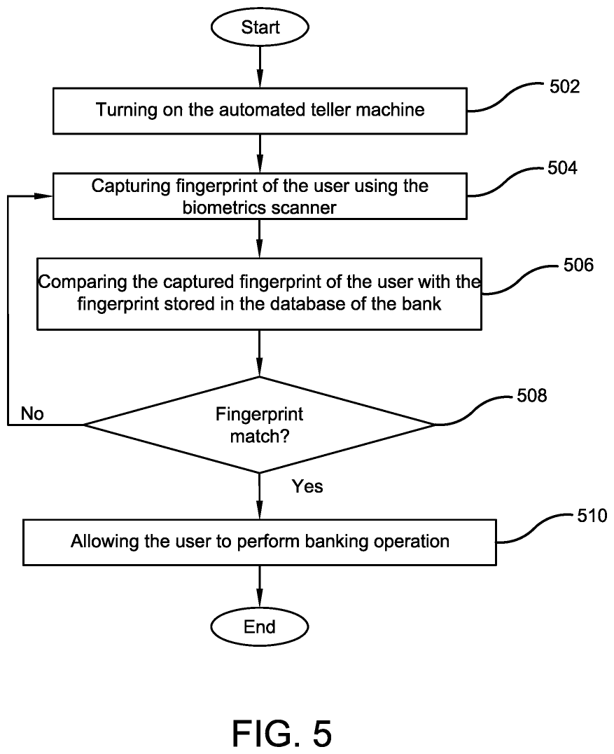

FIG. 5 illustrates a flowchart showing an exemplary method of performing banking operations on one potential embodiment of the biometric automated teller machine 100 of the present invention, using a biometric instead of using a financial card in accordance with the disclosed architecture. Initially, at step 502, the user may turn ON the biometric automated teller machine 100 by pressing a switch (not shown). The switch may generate an activation signal to various components of the biometric automated teller machine 100. Upon receiving the generated activation signal the various components of the biometric automated teller machine 100 are configured to perform their respective tasks. Alternatively, the biometric automated teller machine 100 can be activated using a motion sensor that detects a user approaching the biometric automated teller machine 100. At step 504, users place their fingers or thumbs onto the biometric scanner 104, allowing the scanner to capture the fingerprints. After successfully capturing the fingerprints of the user, at step 506, the biometric automated teller machine 100 compares images of the captured fingerprint of the user with images of fingerprints stored in one or more databases 202 of the bank and/or debit card companies. The comparison can be done at the data center of which the biometric automated teller machine 100 has transmitted the captured fingerprint in a digital form to the data center. At step 508, if the captured fingerprint matches with the registered fingerprints stored in the databases, then the process may proceed to step 510, or else, the process may return to step 504. At step 510, the biometric automated teller machine 100 may allow the user to perform a banking operation. According to embodiments of the present invention, the banking operation may be selected from, cash withdrawal, mini statement, balance check, change of unique PIN or any other banking or financial transaction normally available through an ATM.

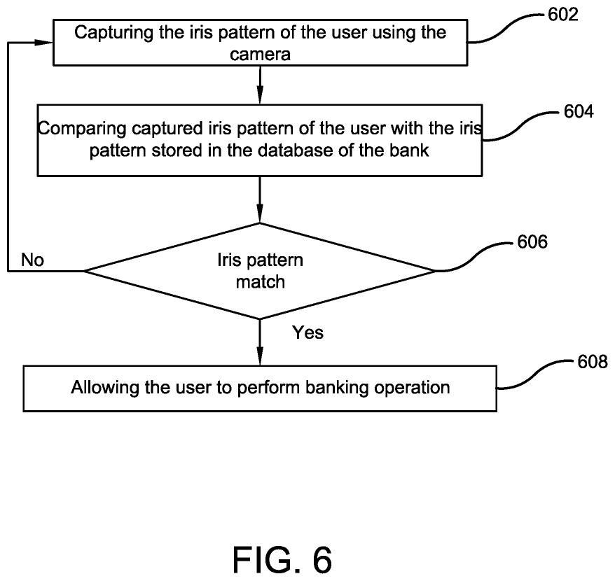

FIG. 6 illustrates a flow chart showing use of an iris pattern as a biometric for allowing banking operations using one potential embodiment of the biometric automated teller machine 100 of the present invention in accordance with the disclosed architecture. Initially, at step 602, the camera 114, installed at the top of the body 102 of the biometric automated teller machine 100 (as shown in FIG. 1), captures an image of the user's iris. Some embodiments of the invention may include an eye piece on the camera to allow a user to better enable the camera to capture an image of the user's iris. Step 604 involves the biometric automated teller machine 100 comparing the captured iris image of the user with the iris image stored in the databases. At step 606, if the captured iris pattern matches with the iris pattern stored in the databases 202, the process will proceed to step 608; else, the process may return to step 602. Upon a successful match of the iris pattern in step 606, the biometric automated teller machine 100 proceeds to step 608 where the automated teller machine 100 allows the user to perform the banking operation such as cash withdrawal, mini statement, balance check, change of unique personal identification number and any other activity normally available through any automated teller machine.

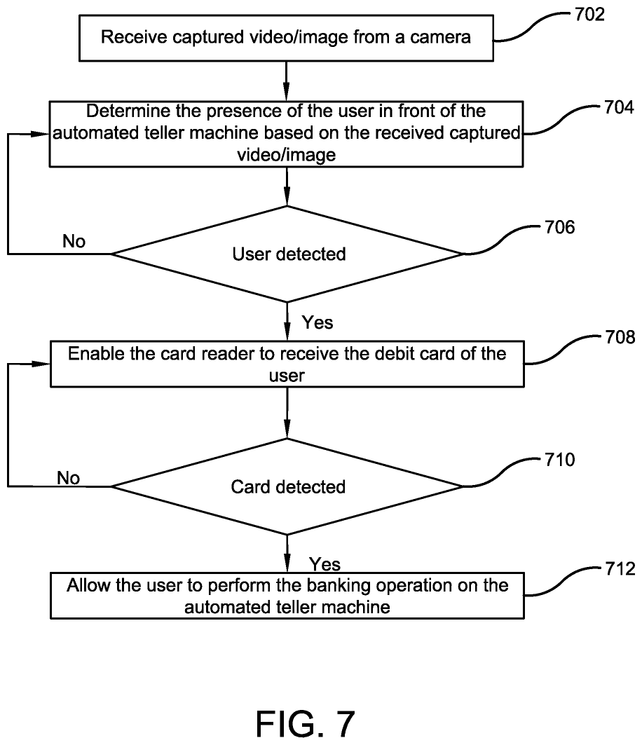

FIG. 7 illustrates a flow diagram showing an exemplary method of performing operations on one potential embodiment of the biometric automated teller machine 100 of the present invention using a financial card in a conventional manner in accordance with the disclosed architecture. It should be appreciated that the flow diagram provides a functionality used in conventional ATMs but is activated only when the biometric scanning is not working or is not opted by the user. Further, the flow diagram provides a method that is used as a backup for the biometric-based authentication as described earlier in the disclosure. At step 702, the biometric automated teller machine 100 receives a captured video/image from the camera 114 installed in the body 102. The camera 114 may be installed in such a way that the user is always in the field of view of the camera 114. Then, at step 704, the biometric automated teller machine 100 may determine the presence of a user based on the received captured video/image. At step 706, if the presence of a user is determined by the biometric automated teller machine 100, then the method may proceed to 708 otherwise the method may return to step 704. At step 708, the biometric automated teller machine 100 enables the card reader 106 to receive a financial card such as a debit or credit card. According to embodiments of the present invention, the financial card may be associated with any bank. At step 710, if the debit card is successfully detected and authenticated by the card reader 106, then the method may proceed to step 712. Otherwise, the method may return to step 708. At step 712, the biometric automated teller machine 100 allows the user to perform various banking operations. The automated teller machine 100 may read the magnetic strip and/or chip of the card. The card reader 106 may decode the information from the magnetic strip/chip, and based on the decoded information the biometric automated teller machine 100 may access the bank account associated with the user. According to embodiments of the present invention, the information encrypted in the magnetic strip/chip may include, but is not limited to, the cardholder's full name, as well as his or her account number, card expiration date, validation code and other pertinent data. Further, the information decoded from the magnetic strip/chip may enable the user to perform banking operations such as, cash withdrawal, mini statement, balance check, change of unique PIN or any other transaction normally available at an ATM.

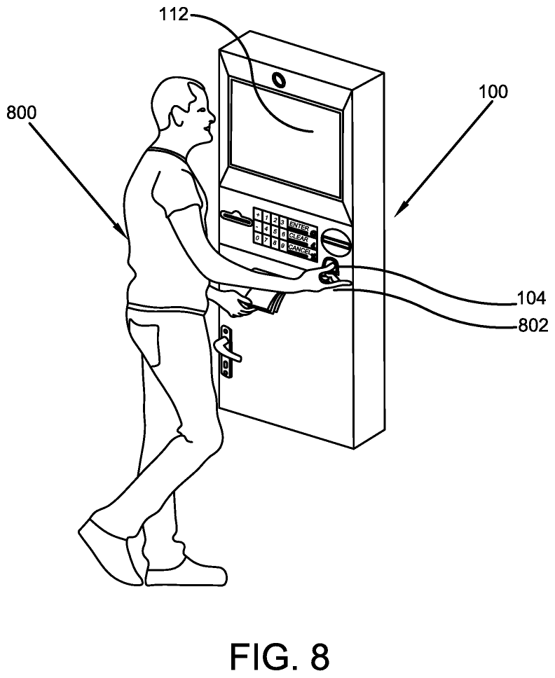

FIG. 8 illustrates an exemplary user performing banking operations on one potential embodiment of the biometric automated teller machine 100 of the present invention in accordance with the disclosed architecture. According to an embodiment of the present invention, the user holding an account in any bank can use the biometric automated teller machine 100 of the present invention after successful authentication of the user's biometric. The novel automated teller machine 100 accepts the fingerprint or other biometric of the user and allows the withdrawal of the cash or any other offered banking operation if the user's biometric matches with the biometric recorded at the time of opening a bank account and/or at the issue of the debit card or at the registration of the biometric on the biometric automated teller machine 100. In an exemplary scenario, as the user 800 walks into the cabin/room where the biometric automated teller machine 100 is placed and scans one or more of his or her fingers 802 on the biometric scanner 104, the biometric scanner 104 captures the fingerprints of the user. If the fingerprint matches the fingerprint recorded at the time of opening a bank account and/or at the issue of the debit card the biometric automated teller machine 100 will allow the user to withdraw the cash just by entering the amount of cash using the user interface 112.

Furthermore, on completion of the transaction or banking operation, the biometric automated teller machine 100 may print a receipt. According to embodiments of the present invention, the receipt may be printed on request of a mini statement, in case of insufficient balance, canceled transaction or other action normally available at an ATM. Embodiments of the present invention are intended to include or otherwise cover any type of receipt including known, related art, and/or later developed technologies.

Certain terms are used throughout the following description and claim to refer to particular features or components. As one skilled in the art will appreciate, different persons may refer to the same feature or component by different names. This document does not intend to distinguish between components or features that differ in name but not structure or function. As used herein “the biometric automated teller machine”, “free-standing automated teller machine”, “biometric ATM”, “ATM” and “device”, are interchangeable and refer to the biometric automated teller machine 100 of the present invention.

Notwithstanding the foregoing, the biometric automated teller machine 100 of the present invention can be of any suitable size and configuration as is known in the art without affecting the overall concept of the invention, provided that it accomplishes the above stated objectives. One of ordinary skill in the art will appreciate that the size, configuration, and material of the biometric automated teller machine 100 as shown in the FIGS. are for illustrative purposes only, and that many other sizes and shapes of the biometric automated teller machine 100 are well within the scope of the present disclosure. Although the dimensions of the biometric automated teller machine 100 are important design parameters for user convenience, the biometric automated teller machine 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automated teller machine with integrated biometric comprising:
a teller machine having a user interface and a cash dispenser;
one or more biometric scanners configured to capture one or more biometric images of a user;
a biometric module having a conversion module configured to convert the one or more biometric images of the user into one or more digital biometric images;
a data center comprised of stored digital biometric images paired with user account details;
an authentication module;
a communication network connecting the authentication module with the data center; and,
an activation module configured to compare the one or more digital biometric images with the stored digital biometric images at the data center, wherein the activation module is configured to activate the user interface and the cash dispenser upon authentication of the user.

2. The automated teller machine with integrated biometric of claim 1, wherein the user interface comprises one or more of a digital display, a touch screen display and a graphical user interface.

3. The automated teller machine with integrated biometric of claim 1, wherein at least one of the one or more biometric scanners is configured to capture an image of one or more user fingerprints.

4. The automated teller machine with integrated biometric of claim 3, wherein the at least one of the one or more biometric scanners is a complementary metal oxide semiconductor (CMOS)-based optical reader.

5. The automated teller machine with integrated biometric of claim 3, wherein the at least one of the one or more biometric scanners is a 500-dpi optical fingerprint sensor.

6. The automated teller machine with integrated biometric of claim 3, wherein at least one of the one or more biometric scanners is configured to capture an image of one or more user irises.

7. The automated teller machine with integrated biometric of claim 6, wherein the at least one of the one or more biometric scanners configured to capture an image of one or more user irises is a camera.

8. The automated teller machine with integrated biometric of claim 1, wherein at least one the one or more biometric scanners is configured to capture an image of one or more user retinas.

9. The automated teller machine with integrated biometric of claim 8, wherein the at least one of the one or more biometric scanners is configured to capture an image of one or more user retinas is a camera.

10. The automated teller machine with integrated biometric of claim 1 further comprising:
a card reader sized and configured to receive a financial card;
a keypad configured to allow the user to enter a personal identification number to authenticate the user;
a camera configured to image a face of the user;
a cash cassette;
a door to access the cash cassette;
a printer configured to print a receipt; and
a printer slot.

11. A method of providing a secure banking operation via an automated teller machine having integrated biometric capabilities, the method comprising the steps of:
scanning one or more biometrics of a user to obtain one or more captured biometric images;
comparing the one or more captured biometric images with a plurality of registered biometric images stored in a database and associated with the user;
authenticating the user based on a match of the one or more captured biometric images with the plurality of registered biometric images stored in the database; and
allowing the user to complete the secure banking operation via the automated teller machine upon successful authentication of the user.

12. The method of claim 11, wherein the one or more captured biometric images are comprised of a fingerprint, an iris scan and a retina scan.

13. A method for registering a user with an automated teller machine, the method comprising the steps of:
receiving account details about the user;
receiving one or more biometric images about the user;
pairing the one or more user biometric images with the account details of the user; and
storing the pairing of the one or more user biometric images with the account details of the user in a database.

14. The method of claim 13, wherein the one or more biometrics are selected from a group consisting of a fingerprint, an iris scan and a retinal scan.

15. The method claim 13 further comprising the steps of:
inserting a financial card into the automated teller machine;
entering a personal identification number to access the account details of the user;
using one or more biometric scanners to capture the one or more biometric images of the user;
pairing the one or more biometric images of the user with the account details of the user; and
storing the pairing of the one or more user biometric images and the account details of the user in a database.

16. The method of claim 15, wherein the one or more biometric scanners is configured to capture one or more user biometric images from a group consisting primarily of a fingerprint, an iris scan and a retina scan.

17. The method of claim 16, wherein the fingerprint is captured with a metal oxide semiconductor (CMOS)-based optical reader.

18. The method of claim 16, wherein the fingerprint is captured with a 500-dpi optical fingerprint sensor.

19. The method of claim 16, wherein the iris scan is captured with a camera.

20. The method of claim 16, wherein the retina scan is captured with a camera.
